(19) United States
(12) Patent Application Publication
(10) Pub. No.: US 2026/0252688 A1
(43) Pub. Date: Aug. 27, 2026

(54) DETECTING DATA CONTENT CORRUPTION THROUGH SELF-SUPERVISED LEARNING ON CONTENT DESCRIPTORS

(71) Applicant: DELL PRODUCTS L.P., Round Rock, TX (US)

(72) Inventors: Avinash Kumar, Patna (IN); Parminder Singh Sethi, Ludhiana (IN); Praveen Kumar, Noida (IN)

(21) Appl. No.: 19/065,889

(22) Filed: Feb. 27, 2025

(51) Int. Cl. G06F 21/55; G06F 21/62

(52) U.S. Cl. CPC G06F 21/554; G06F 21/629; G06F 2221/034

(57) ABSTRACT

An information handling system instantiates a first machine learning model to provide a first description of a first content item, instantiates a second machine learning model to receive the first description and information related to a second content item and to provide a third description of based on the first content item and the information related to the second content item, determines whether the second description represents a malicious attempt to alter the first content item, and blocks editing of the first content item in response to determining that the second description represents the malicious attempt. The second content item is an edited version of the first content item.

### FIELD OF THE DISCLOSURE

This disclosure relates to information handling systems, and more particularly relates to detecting data content corruption through self-supervised learning on content descriptors in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may instantiate a first machine learning model to provide a first description of a first content item, to instantiate a second machine learning model that receives the first description and information related to a second content item and provides a third description of based on the first content item and the information related to the second content item, to determine whether the second description represents a malicious attempt to alter the first content item, and to block editing of the first content item in response to determining that the second description represents the malicious attempt. The second content item may be an edited version of the first content item.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIGS. 1 and 2 are a block diagrams illustrating an information handling system according to various embodiments of the present disclosure; and

FIG. 3 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

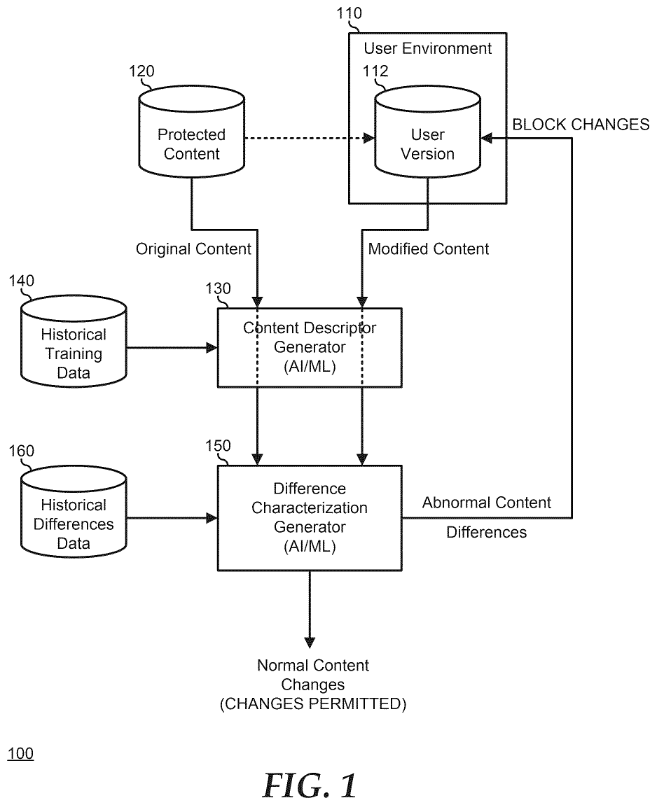

FIG. 1 illustrates an information handling system 100 including a user environment 110, a repository of protected content 120 that is available to the user environment, a content descriptor generator 130, a repository of historical training data 140 for the content descriptor generator, a difference characterization generator 150 and a repository of historical differences data 160. User environment 110 represents a computer device, such as a laptop computer or mobile computing device like a smartphone or tablet device, a desktop or workstation computer, a slim client device, or a remote processing environment instantiated on such a device or computer. User environment 110 is characterized by the fact that the user environment can be utilized to create, modify, delete or otherwise utilize various content items. Such content items may include documents, presentations, spreadsheets, databases, or other types of office productivity content, image files, audio files, video files, or other types of media content, business data content, or any other type of data as needed or desired.

The other elements of information handling system 100 (protected content 120, content descriptor generator 130, historical training data 140, difference characterization generator 150, and historical differences data 160) may be understood to be located in any desired location, as needed or desired. For example, the other elements may be included as elements of user environment 110, may be located remotely from the user environment, or may be located partially as elements of the user environment and partially remotely from the user environment, as needed or desired. In a particular embodiment, the elements of information handling system 100 other than user environment 110 may be located as resources that are available to the user environment in a cloud or as a remote serves that is available to a remote desktop environment instantiated on the user environment, as needed or desired.

Protected content 120 represents content items that are available to user environment 110, but that are generally provided with various access security features, such as authenticated access, encrypted content, or the like. Various items of protected content 120 are provided to user environment 110, and can be created, modified, deleted or otherwise manipulated to change the content item. When a content item is changed, the content item is characterized as a user version 112 of the content item. After a user of user environment 110 changes the user version 112, the changed content can be stored back to protected content 120, as needed or desired.

Typically, when a malicious actor creates a data-based hack, the attack to information handling system 100 takes the form of data deletion or encoding of the data with an encoding controlled by the hacker. However, more recently, data-based hacks involve the manipulation of the content items, without necessarily deleting or reencoding the content items. For example, the contents of a document or presentation may be altered to change the meaning of the document, or media files may be altered to create false or misleading images, or the like. In another case, metadata associated with a content item can be changed to alter the context in which the content item was created or maintained. For example, a creation date may be altered to reflect an earlier or later creation date. Traditional mechanisms for protecting content have not focused on such content manipulation.

In a particular embodiment, information handling system 100 operates to analyze changes made to content items to determine whether the changes represent routine changes as may be expected by a user of host environment 110, or whether the changes represent malicious actions. In particular, information handling system 100 utilizes artificial intelligence/machine learning (AI/ML) algorithms to distinguish between routine changes to protected content 120 and malicious changes to the content. As a first step, a content item from protected content 120 and the associated user version 112 of the content item are both analyzed by content descriptor generator 130 to generate descriptive text for both versions of the content item. Where the content items represent textual content items, content descriptor generator 130 may include a Large Language Model (LLM) to generate summaries of the content items. For example, content descriptor generator 130 may implement a transformer model, a reinforced learning model, a supervised learning model, a self-supervised learning model, an unsupervised learning model, or the like, as needed or desired. Such algorithms may likewise be utilized to generate summaries of audio-based content items or of the audio portions of multimedia content items. Where the content items represent visual information, such as image files, or the video portions of video files, content descriptor generator 130 may utilize an image recognition model, a natural language processor to create human-readable descriptions of the images, or the like.

Content descriptor generator 130 utilizes historical training data 140 to train its AI/ML model. Such historical training data 140 may include various content items and associated descriptions, as needed or desired. The processing of protected content 120 and user version 112 may be performed simultaneously, or the protected content may be pre-processed through content descriptor generator 130, and such pre-processing can be performed at times when the processing resources of information handling system 100 are underutilized, as needed or desired, thereby freeing up the processing resources to generate the content descriptor for only user version in real time.

In a next step, the descriptive text from protected content 120 and from user version 112 of the protected content are forwarded to difference characterization generator 150 to determine if the differences between the protected content and the user version are indicative of normal content changes or are indicative of abnormal content changes. In particular difference characterization generator 150 utilizes a second AI/ML model to autonomously learn from the evolution of content items over time. As such, difference characterization generator 150 continuously monitors and analyzes changes made to the content items, and tracks the legitimate modifications made to the content items during the content item's lifecycle. In particular, by generating descriptions for the differences between protected content 120 and user version 112 over time, the AI/ML model is fine-tuned to understand the nuances of content evolution. In a particular case, difference characterization generator 150 utilizes an LLM that is trained from historical differences data 160 to learn to distinguish between modifications that are a part of the content item's legitimate evolution (such as regular updates or edits by authorized users) and those that are anomalous or potentially malicious (like unauthorized alterations or data corruption).

When the differences are deemed to be normal content differences that are consistent with the normal usage and modification of protected content 120, difference characterization generator 150 permits the current modifications or edits to proceed unhindered. On the other hand, when the differences are deemed to be anomalous or abnormal content differences that are not consistent with the normal usage and modification of protected content 120, difference characterization generator 150 blocks the current modifications or edits to user version 112. In a particular case, when a set of differences represent a border line case between normal and abnormal differences, difference characterization generator 150 provides a warning to the user of user environment 120, to an administrator of protected content 120, or the like, to ensure that a human-based decision is made as to whether to permit the differences to proceed unhindered or to be blocked. Examples of AI/ML models which may be utilized to characterize differences to content items may include various auto-associative self-supervised learning (SSL) models, contrastive SSL models, non-contrastive SSL models, or the like.

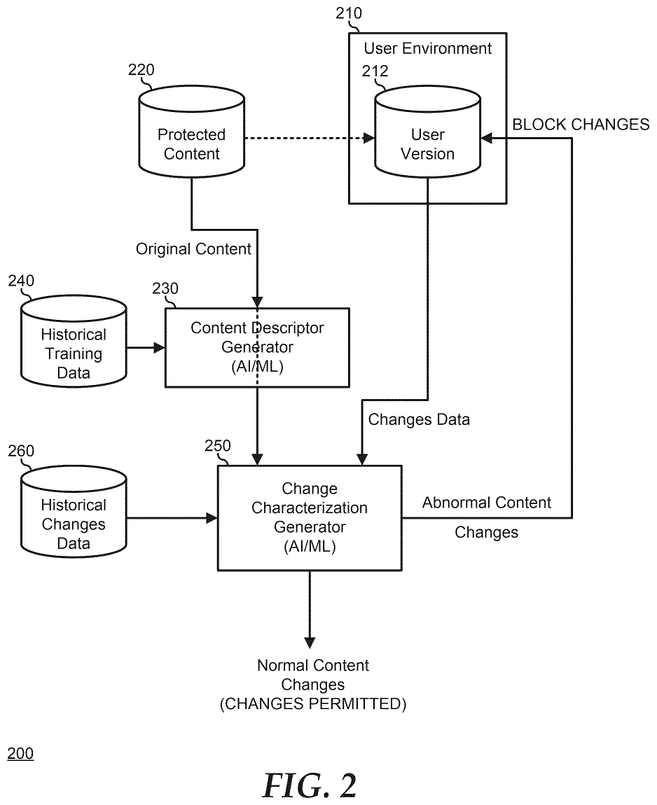

FIG. 2 illustrates an information handling system 200 similar to information handling system 100. In particular, information handling system 200 includes a user environment 210, a repository of protected content 220 that is available to the user environment, a content descriptor generator 230, a repository of historical training data 240 for the content descriptor generator, a change characterization generator 250 and a repository of historical changes data 260. User environment 210 is similar to user environment 110 and includes user version 212 similar to user version 112, and protected content 220 is similar to protected content 120.

In a particular embodiment, information handling system 200 operates to analyze the flow of the changes made to content items to determine whether the changes represent routine changes as may be expected by a user of host environment 210, or whether the changes represent malicious actions. In particular, information handling system 200 utilizes artificial intelligence/machine learning (AI/ML) algorithms to distinguish between routine changes to protected content 220 and malicious changes to the content. As a first step, a content item from protected content 220 is analyzed by content descriptor generator 230 to generate descriptive text for the content item. However, here, content descriptor generator 230 does not analyze user version 212. Content descriptor generator 230 utilizes historical training data 240 to train its AI/ML model.

In a next step, the descriptive text from protected content 220 and the stream of processes performed on user environment 210 to change user version 212 (henceforth referred to as “changes data”) are forwarded to change characterization generator 250 to determine if the differences between the protected content and the user version are indicative of normal content changes or are indicative of abnormal content changes. In particular change characterization generator 250 utilizes a second AI/ML model to autonomously learn from the evolution of content items over time. As such, change characterization generator 250 continuously monitors and analyzes the changes data, and tracks the legitimate modifications made to the content items during the content item's lifecycle. In particular, by generating descriptions for the changes between protected content 220 and user version 212 over time, the AI/ML model is fine-tuned to understand the nuances of content evolution. In a particular case, change characterization generator 250 utilizes an LLM that is trained from historical changes data 260 to learn to distinguish between modifications that are a part of the content item's legitimate evolution (such as regular updates or edits by authorized users) and those that are anomalous or potentially malicious (like unauthorized alterations or data corruption).

When the changes are deemed to be normal content changes that are consistent with the normal usage and modification of protected content 220, change characterization generator 250 permits the current modifications or edits to proceed unhindered. On the other hand, hewn the changes are deemed to be anomalous or abnormal content changes that are not consistent with the normal usage and modification of protected content 220, change characterization generator 250 blocks the current modifications or edits to user version 212. In a particular case, when a set of changes or modifications represent a border line case between normal and abnormal changes or modifications, change characterization generator 250 provides a warning to the user of user environment 210, to an administrator of protected content 220, or the like, to ensure that a human-based decision is made as to whether to permit the changes or modifications to proceed unhindered or to be blocked. Examples of AI/ML models which may be utilized to characterize changes or modifications to content items may include various auto-associative self-supervised learning (SSL) models, contrastive SSL models, non-contrastive SSL models, or the like.

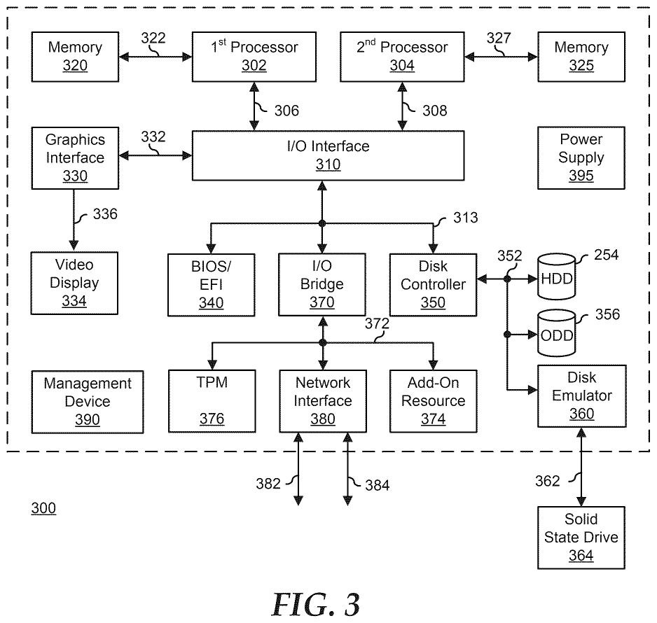

FIG. 3 illustrates a generalized embodiment of an information handling system 300 similar to information handling system 300. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 300 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 300 can include processing resources for executing machine-executable code, such as a central processing unit (CPU), a programmable logic array (PLA), an embedded device such as a System-on-a-Chip (SoC), or other control logic hardware. Information handling system 300 can also include one or more computer-readable medium for storing machine-executable code, such as software or data. Additional components of information handling system 300 can include one or more storage devices that can store machine-executable code, one or more communications ports for communicating with external devices, and various input and output (I/O) devices, such as a keyboard, a mouse, and a video display. Information handling system 300 can also include one or more buses operable to transmit information between the various hardware components.

Information handling system 300 can include devices or modules that embody one or more of the devices or modules described below, and operates to perform one or more of the methods described below. Information handling system 300 includes a processors 302 and 304, an input/output (I/O) interface 310, memories 320 and 325, a graphics interface 330, a basic input and output system/universal extensible firmware interface (BIOS/UEFI) module 340, a disk controller 350, a hard disk drive (HDD) 354, an optical disk drive (ODD) 356, a disk emulator 360 connected to an external solid state drive (SSD) 362, an I/O bridge 370, one or more add-on resources 374, a trusted platform module (TPM) 376, a network interface 380, a management device 390, and a power supply 395. Processors 302 and 304, I/O interface 310, memory 320, graphics interface 330, BIOS/UEFI module 340, disk controller 350, HDD 354, ODD 356, disk emulator 360, SSD 362, I/O bridge 370, add-on resources 374, TPM 376, and network interface 380 operate together to provide a host environment of information handling system 300 that operates to provide the data processing functionality of the information handling system. The host environment operates to execute machine-executable code, including platform BIOS/UEFI code, device firmware, operating system code, applications, programs, and the like, to perform the data processing tasks associated with information handling system 300.

In the host environment, processor 302 is connected to I/O interface 310 via processor interface 306, and processor 304 is connected to the I/O interface via processor interface 308. Memory 320 is connected to processor 302 via a memory interface 322. Memory 325 is connected to processor 304 via a memory interface 327. Graphics interface 330 is connected to I/O interface 310 via a graphics interface 332, and provides a video display output 336 to a video display 334. In a particular embodiment, information handling system 300 includes separate memories that are dedicated to each of processors 302 and 304 via separate memory interfaces. An example of memories 320 and 330 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 340, disk controller 350, and I/O bridge 370 are connected to I/O interface 310 via an I/O channel 312. An example of I/O channel 312 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 310 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 340 includes BIOS/UEFI code operable to detect resources within information handling system 300, to provide drivers for the resources, initialize the resources, and access the resources. BIOS/UEFI module 340 includes code that operates to detect resources within information handling system 300, to provide drivers for the resources, to initialize the resources, and to access the resources.

Disk controller 350 includes a disk interface 352 that connects the disk controller to HDD 354, to ODD 356, and to disk emulator 360. An example of disk interface 352 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 360 permits SSD 364 to be connected to information handling system 300 via an external interface 362. An example of external interface 362 includes a USB interface, an IEEE 1394 (Firewire) interface, a proprietary interface, or a combination thereof. Alternatively, solid-state drive 364 can be disposed within information handling system 300.

I/O bridge 370 includes a peripheral interface 372 that connects the I/O bridge to add-on resource 374, to TPM 376, and to network interface 380. Peripheral interface 372 can be the same type of interface as I/O channel 312, or can be a different type of interface. As such, I/O bridge 370 extends the capacity of I/O channel 312 where peripheral interface 372 and the I/O channel are of the same type, and the I/O bridge translates information from a format suitable to the I/O channel to a format suitable to the peripheral channel 372 where they are of a different type. Add-on resource 374 can include a data storage system, an additional graphics interface, a network interface card (NIC), a sound/video processing card, another add-on resource, or a combination thereof. Add-on resource 374 can be on a main circuit board, on separate circuit board or add-in card disposed within information handling system 300, a device that is external to the information handling system, or a combination thereof.

Network interface 380 represents a NIC disposed within information handling system 300, on a main circuit board of the information handling system, integrated onto another component such as I/O interface 310, in another suitable location, or a combination thereof. Network interface device 380 includes network channels 382 and 384 that provide interfaces to devices that are external to information handling system 300. In a particular embodiment, network channels 382 and 384 are of a different type than peripheral channel 372 and network interface 380 translates information from a format suitable to the peripheral channel to a format suitable to external devices. An example of network channels 382 and 384 includes InfiniBand channels, Fibre Channel channels, Gigabit Ethernet channels, proprietary channel architectures, or a combination thereof. Network channels 382 and 384 can be connected to external network resources (not illustrated). The network resource can include another information handling system, a data storage system, another network, a grid management system, another suitable resource, or a combination thereof.

Management device 390 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 300. In particular, management device 390 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 300, such as system cooling fans and power supplies. Management device 390 can include a network connection to an external management system, and the management device can communicate with the management system to report status information for information handling system 300, to receive BIOS/UEFI or system firmware updates, or to perform other task for managing and controlling the operation of information handling system 300. Management device 390 can operate off of a separate power plane from the components of the host environment so that the management device receives power to manage information handling system 300 where the information handling system is otherwise shut down. An example of management device 390 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 390 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a memory device to store code; and
a processor to execute code, the processor configured to:
instantiate a first machine learning model to provide a first description of a first content item;
instantiate a second machine learning model to receive the first description and information related to a second content item, and to provide a third description of based on the first content item and the information related to the second content item, wherein the second content item is an edited version of the first content item;
determine whether the second description represents a malicious attempt to alter the first content item; and
block edit the first content item in response to determining that the second description represents the malicious attempt.

2. The information handling system of claim 1, wherein the first machine learning model further provides a third description of the second content item.

3. The information handling system of claim 2, wherein the information related to the second content item includes the third description.

4. The information handling system of claim 3, wherein in determining whether the second description represents the malicious attempt, the second machine learning model is further to compare a difference between the first description and the third description.

5. The information handling system of claim 4, wherein the second machine learning model is trained based upon historical differences between content items.

6. The information handling system of claim 1, wherein the information related to the second content item includes changes made to the first content item.

7. The information handling system of claim 6, wherein in determining whether the second description represents the malicious attempt, the second machine learning model is further to determine a difference between the first description and the changes made to the first content item.

8. The information handling system of claim 7, wherein the second machine learning model is trained based upon historical changes made to content items.

9. The information handling system of claim 1, wherein the processor is further configured to permit further editing of the first content item in response to determining that the second description does not represent the malicious attempt.

10. The information handling system of claim 1, wherein the first machine learning model is trained based upon descriptions of historical content items.

11. A method, comprising:
instantiating, by an information handling system, a first machine learning model;
providing, by the first machine learning model, a first description of a first content item;
instantiating a second machine learning model;
receiving, by the second machine learning model, the first description and information related to a second content item, wherein the second content item is an edited version of the first content item;
providing, by the second machine learning model, a third description of based on the first content item and the information related to the second content item,
determining whether the second description represents a malicious attempt to alter the first content item; and
blocking editing of the first content item in response to determining that the second description represents the malicious attempt.

12. The method of claim 11, further comprising providing, by the first machine learning model, a third description of the second content item.

13. The method of claim 12, wherein the information related to the second content item includes the third description.

14. The method of claim 13, wherein in determining whether the second description represents the malicious attempt, the method further comprises comparing, by the second machine learning model, a difference between the first description and the third description.

15. The method of claim 14, further comprising training the second machine learning model based upon historical differences between content items.

16. The method of claim 11, wherein the information related to the second content item includes changes made to the first content item.

17. The method of claim 16, wherein in determining whether the second description represents the malicious attempt, the method further comprises determining, by the second machine learning model, a difference between the first description and the changes made to the first content item.

18. The method of claim 17, further comprising training the second machine learning model based upon historical changes made to content items.

19. The method of claim 11, further comprising permitting further editing of the first content item in response to determining that the second description does not represent the malicious attempt.

20. An information handling system, comprising:
a storage device to store content items; and
a processor configured to:
retrieve a first content item from the storage device;
provide edits to the first content item to create a second content item;
instantiate a first machine learning model to provide a first description of the first content item;
instantiate a second machine learning model to receive the first description and information related to the second content item, and to provide a third description of based on the first content item and the information related to the second content item;
determine whether the second description represents a malicious attempt to alter the first content item; and
block editing the first content item in response to determining that the second description represents the malicious attempt.
